(19) United States
(12) Patent Application Publication
(10) Pub. No.: US 2025/0229728 A1
(43) Pub. Date: Jul. 17, 2025

(54) VEHICLE EXTERIOR COMPONENT

(71) Applicant: TOYODA GOSEI CO., LTD., Kiyosu-shi (JP)

(72) Inventors: Shota YAMAMORI, Kiyosu-shi (JP); Kozo HIROTANI, Kiyosu-shi (JP); Tomoki KAWASAKI, Kiyosu-shi (JP); Akiko KIMURA, Kiyosu-shi (JP)

(21) Appl. No.: 18/962,431

(22) Filed: Nov. 27, 2024

(30) Foreign Application Priority Data
Jan. 12, 2024 (JP) 2024-003459

(51) Int. Cl. B60R 13/00; H01Q 1/02; H01Q 1/32; H01Q 1/42

(52) U.S. Cl. CPC B60R 13/00; H01Q 1/02; H01Q 1/32; H01Q 1/42

(57) ABSTRACT

A vehicle exterior component includes a plate-shaped base formed of a plastic, a heater sheet stacked on one end face of the base in a thickness direction of the base, and a colored layer formed of a plastic in which a colorant is dispersed or of a paint containing a coloring pigment. The one end face of the base forms a surface on which a decorative surface of the vehicle exterior component is located. The heater sheet includes a plastic sheet base joined to the one end face of the base, and a heating wire that is routed along the sheet base. The colored layer is provided on a side of the sheet base that is opposite to the base in the thickness direction.

### CROSS-REFERENCE TO RELATED APPLICATIONS

This application is based upon and claims the benefit of priority from prior Japanese Patent Application No. 2024-003459, filed on Jan. 12, 2024, the entire contents of which are incorporated herein by reference.

### BACKGROUND

### 1. Field

The present disclosure relates to a vehicle exterior component.

### 2. Description of Related Art

A radome is disposed forward of a vehicle on-board radar device. The radome includes a plastic base, a plastic transparent base, which is disposed forward of the base and forms a decorative surface of the radome, and a plastic rear base, which is disposed rearward of the base and faces the vehicle on-board radar device.

A decorative layer having metallic luster is provided between the base and the transparent base. A planar heating element formed by fixing a heating wire to an insulation film is provided between the base and the rear base.

The decorative layer imparts a sparkling effect to the radome, while the planar heating element provides a snow-melting function.

Exterior members such as a bumper and a grille are arranged around the radome. These exterior members each have a colored layer, such as a coating film, on the outermost surface. The appearance of the radome, which has the transparent base on its outermost surface, thus differs from the appearance of the surrounding exterior members. Therefore, there is room for improvement in the uniformity of appearance between an exterior component such as a radome and exterior members arranged around the exterior component.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle exterior component includes a plate-shaped base formed of a plastic, a heater sheet stacked on one end face of the base in a thickness direction of the base, and a colored layer formed of a plastic in which a colorant is dispersed or formed of a paint containing a coloring pigment. The one end face of the base forms a surface on which a decorative surface of the vehicle exterior component is located. The heater sheet includes a plastic sheet base joined to the one end face of the base, and a heating wire that is routed along the sheet base and generates heat when energized. The colored layer is provided on a side of the sheet base that is opposite to the base in the thickness direction.

In another general aspect, a vehicle exterior component includes a plate-shaped base formed of a plastic and a heater sheet stacked on one end face of the base in a thickness direction of the base. The one end face of the base forms a surface on which a decorative surface of the vehicle exterior component is located. The heater sheet includes a plastic sheet base joined to the one end face of the base, and a heating wire that is routed along the sheet base and generates heat when energized. A colorant is dispersed in the sheet base.

Other features and aspects will be apparent from the following detailed description, the drawings, and the claims.

### BRIEF DESCRIPTION OF THE DRAWINGS

FIG. 1 is a front view of a vehicle to which a vehicle exterior component according to a first embodiment is attached.

FIG. 2 is an enlarged front view of a main part of the vehicle exterior component shown in FIG. 1.

FIG. 3 is a cross-sectional view taken along line 3-3 of FIG. 2.

FIG. 4 is a cross-sectional view corresponding to FIG. 3, showing a vehicle exterior component according to a second embodiment.

FIG. 5 is a cross-sectional view corresponding to FIG. 3, showing a vehicle exterior component according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

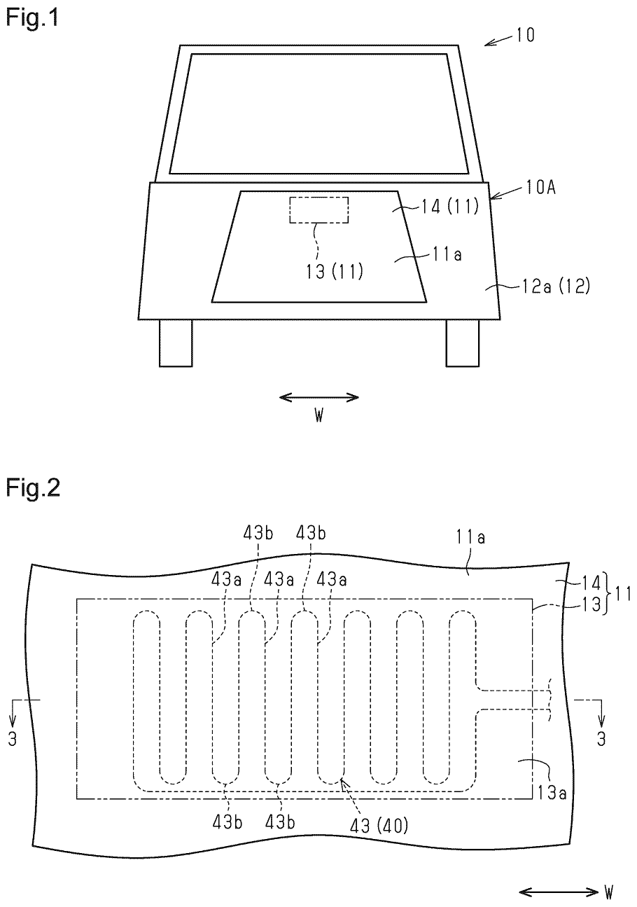

Vehicle exterior components according to embodiments will now be described with reference to FIGS. 1 to 4.

The front-rear direction of a vehicle 10 will hereafter be referred to as a front-rear direction L, and the ‘forward’ and ‘rearward’ in the front-rear direction L will simply be referred to as ‘forward’ and ‘rearward’. The width direction of the vehicle 10 will simply be referred to as the vehicle width direction W.

### First Embodiment

First, a vehicle exterior component according to a first embodiment will be described with reference to FIGS. 1 to 3.

### Front Portion 10A of Vehicle 10

As shown in FIGS. 1 and 2, a first exterior member 11 and a second exterior member 12, which form a part of an outer shell of the vehicle 10, are provided in a front portion 10A of the vehicle 10.

The first exterior member 11 forms a central portion of the front portion 10A in the vehicle width direction W, as viewed from the front. The first exterior member 11 corresponds to a vehicle exterior component according to the present disclosure.

The second exterior member 12 is, for example, what is called a front bumper, and forms a peripheral portion of the first exterior member 11 in the front portion 10A, as viewed from the front. The second exterior member 12 includes a decorative surface 12a that is flush with a decorative surface 11a of the first exterior member 11.

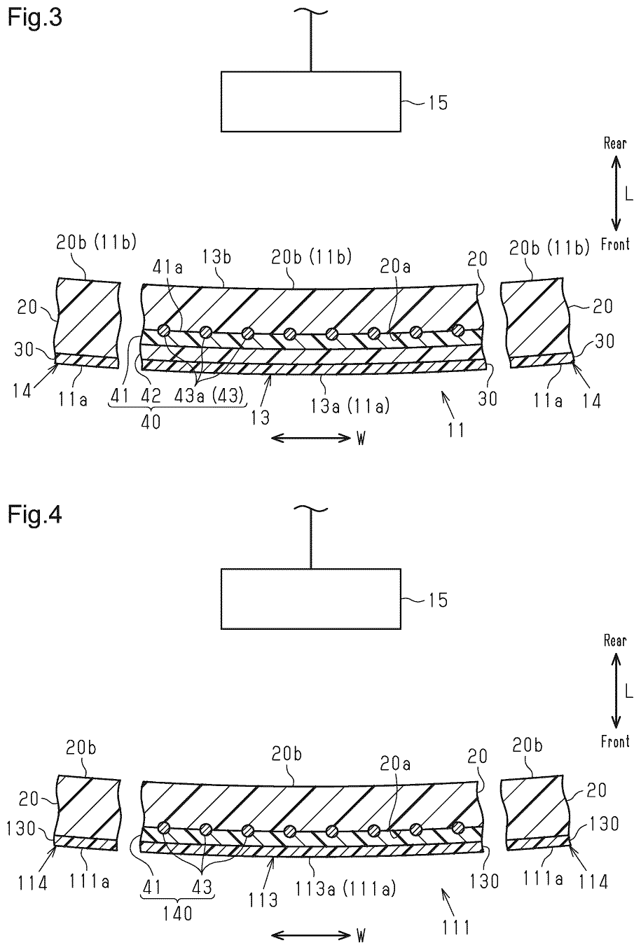

As shown in FIG. 3, a radar device 15 is disposed behind the first exterior member 11. The radar device 15 is a vehicle on-board sensor that emits and receives electromagnetic waves for detecting objects outside the vehicle 10. In the present embodiment, the radar device 15 emits electromagnetic waves, which are millimeter waves having a wavelength in a range of 1 mm to 10 mm and a frequency in a range of 30 GHz to 300 GHz.

### First Exterior Member 11

As shown in FIG. 3, the first exterior member 11 includes a base 20 formed of a plastic, and a colored layer 30 disposed forward of the base 20.

The base 20 has a plate shape having a front surface 20a and a rear surface 20b at one end (front side) and the other end (rear side) in the front-rear direction L, respectively. The front surface 20a forms a surface of the first exterior member 11 on which the decorative surface 11a is disposed. The rear surface 20b forms a surface 11b of the first exterior member 11 that is on the side opposite to the decorative surface 11a. In the present embodiment, the front-rear direction L corresponds to the thickness direction of a base according to the present disclosure, and the front surface 20a corresponds to one end face in the thickness direction of the base according to the present disclosure.

The coefficient of linear expansion of the plastic forming the base 20 is less than or equal to 1.0×10⁻⁴/° C.

The Young's modulus of the plastic forming the base 20 is higher than or equal to 2.0 GPa.

The plastic forming the base 20 is preferably a transparent plastic having visible light transparency. The term “transparent” in the present embodiment includes not only colorless and transparent but also colored and transparent (colored transparent). In the present embodiment, the base 20 is formed of a polycarbonate (PC) plastic.

As shown in FIG. 3, the colored layer 30 is a coating film formed of a paint containing a coloring pigment, and forms the decorative surface 11a of the first exterior member 11.

Examples of the coloring pigment include inorganic pigments such as titanium oxide and carbon black, in addition to organic pigments.

As the paint, a known synthetic resin paint such as a polyester resin-based paint, an acrylic resin-based paint, an epoxy resin-based paint, a melamine resin-based paint, a urethane resin-based paint, or a silicone resin-based paint can be used.

The paint may contain a pigment other than the coloring pigment, for example, a sparkle pigment such as aluminum flakes or pearl mica particles, or an extender pigment.

The paint may be obtained by appropriately mixing a solvent, a curing agent, a catalyst, and the like in addition to any of the resins and the pigments described above, or may be obtained by adding known additives for a paint such as a plasticizer, a dispersant, an antisettling agent, an antifoaming agent, a surface conditioner, and a stabilizer (deterioration inhibitor).

### Sensor Cover Portion 13

A portion of the first exterior member 11 indicated by the long-dash double-short-dash lines in FIGS. 1 and 2 form a sensor cover portion 13 that covers the radar device 15 from the front. The sensor cover portion 13 has millimeter wave transparency.

Hereinafter, a portion of the first exterior member 11 other than the sensor cover portion 13 will be described as a general portion 14. In the present embodiment, the sensor cover portion 13 and the general portion 14 are formed integrally.

As shown in FIG. 3, a decorative surface 13a of the sensor cover portion 13 forms a part of the decorative surface 11a of the first exterior member 11, and is flush with a portion of the decorative surface 11a that corresponds to the general portion 14. Further, a surface 13b of the sensor cover portion 13 on the side opposite to the decorative surface 13a forms a part of the surface 11b of the first exterior member 11, and is flush with a portion of the surface 11b that corresponds to the general portion 14.

As shown in FIGS. 2 and 3, the sensor cover portion 13 includes a heater sheet 40 between the base 20 and the colored layer 30 in the front-rear direction L.

The heater sheet 40 includes a first sheet base 41 and a second sheet base 42, which are made of plastic, and a heating wire 43, which generates heat when energized.

The first sheet base 41 is stacked on and joined to the front surface 20a of the base 20.

The coefficient of linear expansion of the plastic forming the first sheet base 41 is less than or equal to 1.0×10⁻⁴/° C.

The Young's modulus of the plastic forming the first sheet base 41 is higher than or equal to 2.0 GPa.

The plastic forming the first sheet base 41 is preferably the same as the plastic forming the base 20 from the viewpoint of the degree of surface contact with the base 20. In the present embodiment, the first sheet base 41 is formed of PC.

The second sheet base 42 is disposed between the first sheet base 41 and the colored layer 30 in the front-rear direction L.

The coefficient of linear expansion of the plastic forming the second sheet base 42 is less than or equal to 1.0 ×10⁻⁴/° C.

The Young's modulus of the plastic forming the second sheet base 42 is higher than or equal to 2.0 GPa.

The plastic forming the second sheet base 42 preferably has a higher weather resistance than the plastic forming the first sheet base 41. In the present embodiment, the second sheet base 42 is formed of a polymethyl methacrylate (PMMA) plastic.

The first sheet base 41 and the second sheet base 42 are integrally formed in a sheet shape by coextrusion, for example.

As shown in FIGS. 2 and 3, the heating wire 43 is formed of a metal lead, and is routed along the rear surface 41a of the first sheet base 41 in a specified wiring pattern. Specifically, the heating wire 43 is routed in a wiring pattern having multiple linear portions 43a extending parallel to each other and multiple connecting portions 43b connecting ends of the linear portions 43a adjacent to each other in the vehicle width direction W (see FIG. 2).

For example, the heating wire 43 is routed on the rear surface 41a by being pressed against the rear surface 41a of the sheet base 41 to be embedded therein while being heated.

### Manufacturing Procedure of First Exterior Member 11

The first exterior member 11, which has the above-described configuration, is manufactured through the following manufacturing procedure, for example.

First, the base 20 is injection-molded using the heater sheet 40 as an insert member. Thus, the heater sheet 40 is joined to the base 20. Specifically, the first sheet base 41 of the heater sheet 40 and the base 20 are joined to each other.

Next, the same paint as that of the colored layer (not shown) forming the decorative surface 12a of the second exterior member 12 is applied to the base 20, to which the heater sheet 40 is joined. Thus, the first exterior member 11 on which the colored layer 30 is formed is obtained.

### Operation of First Embodiment

Operation of the present embodiment will now be described.

The colored layer 30, which is formed of a paint containing a coloring pigment, is disposed on the outermost surface of the first exterior member 11. Thus, the first exterior member 11 has the colored layer 30 on the outermost surface, like the second exterior member 12, which is another general exterior member disposed around the first exterior member 11. Therefore, matching the color of the colored layer 30 with the color of the colored layer of the surrounding second exterior member 12 improves the uniformity of the appearance between the first exterior member 11 and the surrounding second exterior member 12.

Further, the heater sheet 40 is stacked on the front surface 20a of the base 20. Thus, the heater sheet 40 is disposed at a position closer to the decorative surface 13a of the sensor cover portion 13 in the front-rear direction L than in a case in which the heater sheet 40 is stacked on the rear surface 20b of the base 20. Therefore, the Joule heat of the heater sheet 40 is readily transferred to the decorative surface 13a of the sensor cover portion 13, so that the ice and snow accumulated on the decorative surface 13a are melted efficiently. Furthermore, since the heater sheet 40 is covered with the colored layer 30, the heater sheet 40 is not visible. Therefore, the aesthetic properties of the sensor cover portion 13, and consequently of the first exterior member 11, are not impaired.

### Advantages of First Embodiment

The present embodiment has the following advantages.

(1-1) The first exterior member 11 includes the plate-shaped base 20 formed of plastic (PC), the heater sheet 40 stacked on the front surface 20a of the base 20, and the colored layer 30 formed of a paint containing coloring pigments. The heater sheet 40 includes the first sheet base 41, which is joined to the front surface 20a, and the heating wire 43, which is routed along the first sheet base 41 and generates heat when energized. The colored layer 30 is provided on the side of the first sheet base 41 that is opposite to the base 20 in the front-rear direction L.

This configuration, which operates in the above-described manner, improves the uniformity of the appearance of the first exterior member 11 and the second exterior member 12, which is disposed around the first exterior member 11, while improving the snow-melting function.

(1-2) The base 20 has visible light transparency. The base 20 forms the surface 11b of the first exterior member 11, which is on the side opposite to the decorative surface 11a.

According to this configuration, since the base 20 has visible light transparency, the heating wire 43 of the heater sheet 40 is visible from the surface 11b of the first exterior member 11, which is on the side opposite to the decorative surface 11a. This facilitates the inspection of the heating wire 43.

(1-3) The second sheet base 42 formed of plastic (PMMA) having a higher weather resistance than the plastic (PC) forming the first sheet base 41 is provided between the first sheet base 41 and the colored layer 30 in the front-rear direction L.

Since the plastic forming the first sheet base 41 and the base 20 is PC, the first sheet base 41 and the base 20 are prone to yellowing due to ultraviolet rays. In this regard, according to the above-described configuration, the second sheet base 42 suppresses yellowing of the first sheet base 41 and the base 20.

(1-4) The sensor cover portion 13 of the first exterior member 11 has millimeter wave transparency.

In the first exterior member 11, which is disposed forward of the radar device 15, when ice or snow accumulates on the decorative surface 13a, millimeter waves transmitted through the sensor cover portion 13 of the first exterior member 11 are attenuated by the ice and snow. Thus, there is a concern that the detection function of the radar device 15 may be degraded.

In this regard, the above-described configuration allows the Joule heat of the heater sheet 40 to be readily transferred to the decorative surface 13a of the sensor cover portion 13, so that the ice and snow accumulated on the decorative surface 13a are melted efficiently. Therefore, attenuation of the millimeter waves due to accumulation of ice and snow is suppressed.

### Second Embodiment

Next, a vehicle exterior component according to a second embodiment will be described with reference to FIG. 4. In a first exterior member 111 according to the second embodiment, the configurations of a sensor cover portion 113 and a colored layer 130 are different from those of the first embodiment.

The description hereafter will focus on differences from the first embodiment.

In the second embodiment, the same reference numerals are given to those components that are the same as those in the first embodiment. Also, reference numerals 1**, which are obtained by adding 100 to the reference numerals ** in the first embodiment, are given to the corresponding components, and redundant explanations are omitted.

As shown in FIG. 4, the first exterior member 111 includes the base 20 and the colored layer 130.

The first exterior member 111 includes the sensor cover portion 113, which covers the radar device 15 from the front, and a general portion 114, which is a portion other than the sensor cover portion 113.

The sensor cover portion 113 includes a heater sheet 140 between the base 20 and the colored layer 130. In the heater sheet 140 of the present embodiment, the second sheet base 42 is omitted from the heater sheet 40 of the first embodiment.

The colored layer 130 is formed of a plastic in which a colorant is dispersed.

The coefficient of linear expansion of the plastic forming the colored layer 130 is preferably less than or equal to 1.0 ×10⁻⁴/° C.

The Young's modulus of the plastic forming the colored layer 130 is preferably higher than or equal to 2.0 GPa.

The colored layer 130 is preferably formed of a plastic having a higher weather resistance than the plastic forming the sheet base 41. In the present embodiment, the colored layer 130 is formed of PMMA.

As the colorant, known dye-based, pigment-based, and chemical-based colorants can be used.

### Manufacturing Procedure of First Exterior Member 111

The first exterior member 111, which has the above-described configuration, is manufactured in the following manner, for example.

First, the base 20 is injection-molded using the heater sheet 140 as an insert member. Thus, the heater sheet 140 is joined to the base 20.

Next, the colored layer 130 is joined to the base 20, to which the heater sheet 140 is joined. Thus, the first exterior member 111, which includes the colored layer 130, is obtained.

### Operation and Advantages of Second Embodiment

The present embodiment has the following advantages.

In addition to the advantages (1-2) to (1-4) of the first embodiment, the present embodiment has the advantage described below.

(2-1) The first exterior member 111 includes the plate-shaped base 20 formed of plastic (PC) and the heater sheet 140 stacked on the front surface 20a of the base 20. The heater sheet 140 includes the sheet base 41, which is joined to the front surface 20a, and the heating wire 43, which is routed along the sheet base 41 and generates heat when energized. The colored layer 130, formed of plastic (PMMA) in which a colorant is dispersed, is provided on the side of the sheet base 41 opposite to the base 20 in the front-rear direction L.

According to this configuration, the colored layer 130, formed of plastic (PMMA) in which a colorant is dispersed, is disposed on the outermost surface of the first exterior member 111. Thus, the first exterior member 111 has the colored layer 130 on the outermost surface, like the second exterior member 12, which is another general exterior member disposed around the first exterior member 111. Therefore, matching the color of the colored layer 130 with the color of the colored layer (not shown) of the surrounding second exterior member 12 improves the uniformity of the appearance between the first exterior member 111 and the surrounding second exterior member 12.

Further, the heater sheet 140 is stacked on the front surface 20a of the base 20. Thus, the heater sheet 140 is disposed at a position closer to the decorative surface 113a of the sensor cover portion 113 in the front-rear direction L than in a case in which the heater sheet 140 is stacked on the rear surface 20b of the base 20. Therefore, the Joule heat of the heater sheet 140 is readily transferred to the decorative surface 113a of the sensor cover portion 113, so that the ice and snow accumulated on the decorative surface 113a are melted efficiently. Furthermore, since the heater sheet 140 is covered with the colored layer 130, the heater sheet 140 is not visible. Therefore, the aesthetic properties of the sensor cover portion 113, and consequently of the first exterior member 111, are not impaired.

This configuration thus improves the uniformity of the appearance of the first exterior member 111 and the second exterior member 12, which is disposed around the first exterior member 111, while improving the snow-melting function.

(2-2) The colored layer 130 is formed of plastic (PMMA) in which a colorant is dispersed and which has a higher weather resistance than the plastic (PC) forming the sheet base 41.

According to this configuration, the colored layer 130 imparts a relatively high weather resistance to the heater sheet 140. Thus, the layer configuration of the heater sheet 140 is simplified as compared with a case in which a plastic layer formed of PMMA, which is a plastic having a higher weather resistance than the sheet base 41, is separately provided between the colored layer 130 and the sheet base 41. Therefore, a relatively high weather resistance is imparted to the heater sheet 140 with a simple configuration.

### Modifications

The above-described embodiments may be modified as follows. The above-described described embodiments and the following modifications can be combined as long as the combined modifications remain technically consistent with each other. In the modifications, the same reference numerals are given to those components that are the same as those in the second embodiment. Also, reference numerals 2**, which are obtained by adding 100 or 200to the reference numerals ** in the second embodiment, are given to the corresponding components, and redundant explanations are omitted.

The base 20 does not necessarily need to have visible light transparency. The base 20 may be formed of, for example, a material that is prepared by mixing PC and carbon black and has a light-shielding property.

In the above-described embodiments, the (first) sheet base 41 and the base 20 are joined to each other by injection-molding the base 20 using the heater sheet 40 (140) as an insert member. However, the method of joining the heater sheet 40 (140) and the base 20 is not limited thereto. The first exterior member 11 (111) may be configured such that, for example, the (first) sheet base 41 and the base 20 are joined to each other by bonding the heater sheet 40 (140) to the front surface 20a of the injection-molded base 20.

The radar device 15 may detect an object outside the vehicle 10 by emitting and receiving electromagnetic waves other than millimeter waves, for example, infrared rays. In this case, the sensor cover portion 13 (113) of the first exterior member 11 (111) is not limited to one having millimeter wave transparency as exemplified in the above-described embodiments, and may be one having transparency to electromagnetic waves emitted and received by the radar device 15.

The heater sheet 40 may be configured such that an adhesive is interposed between the first sheet base 41 and the second sheet base 42.

The second sheet base 42 is not limited to being formed of a plastic having a higher weather resistance than the plastic forming the first sheet base 41. The plastic forming the second sheet base 42 may be the same as the plastic forming the first sheet base 41 or may have a lower weather resistance than the plastic forming the first sheet base 41 as long as the plastic forming the second sheet base 42 has a coefficient of linear expansion less than or equal to 1.0×10⁻⁴/° C. and a Young's modulus higher than or equal to 2.0 GPa.

The colored layer 130 is not limited to being formed of a plastic having a higher weather resistance than the plastic forming the sheet base 41. The plastic forming the colored layer 130 may be the same as the plastic forming the first sheet base 41 or may have a lower weather resistance than the plastic forming the first sheet base 41 as long as the plastic forming the colored layer 130 has a coefficient of linear expansion less than or equal to 1.0×10⁻⁴/° C. and a Young's modulus higher than or equal to 2.0 GPa.

The heater sheet 40 is not limited to one formed by the first sheet base 41, the second sheet base 42, and the heating wire 43 as illustrated in the first embodiment. For example, the heater sheet 40 may lack the second sheet base 42, or may further include an additional sheet base made of plastic in addition to the first sheet base 41 and the second sheet base 42. In this case, the plastic forming the additional sheet base may have any properties as long as it has a coefficient of linear expansion less than or equal to 1.0×10⁻⁴/° C. and a Young's module higher than or equal to 2.0 GPa.

The heater sheet 140 is not limited to one formed by the sheet base 41 and the heating wire 43 as illustrated in the second embodiment. For example, the heater sheet 140 may include an additional sheet base made of plastic between the colored layer 130 and the sheet base 41. In this case, the plastic forming the additional sheet base may have any properties as long as it has a coefficient of linear expansion less than or equal to 1.0×10⁻⁴/° C. and a Young's module higher than or equal to 2.0 GPa.

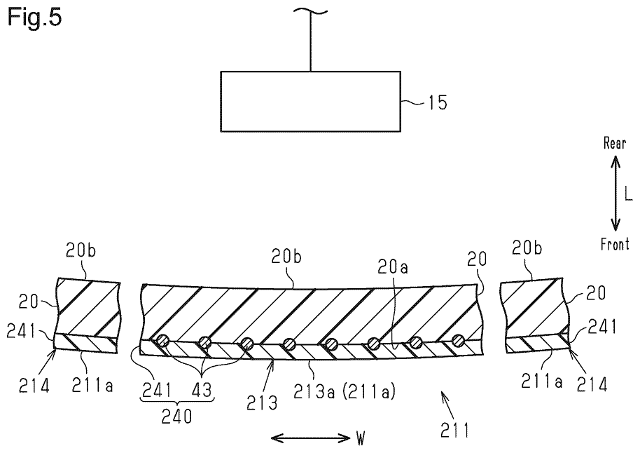

The vehicle exterior components according to the present disclosure are not limited to components including both the sheet base 41 and the colored layer 130 as in the first exterior member 111 exemplified in the second embodiment. For example, as shown in FIG. 5, the present disclosure can be embodied as a first exterior member 211 in which the colored layer 130 is omitted from the first exterior member 111. As shown in FIG. 5, the decorative surface 211a of the first exterior member 211 is formed by a sheet base 241 of a heater sheet 240. That is, a decorative surface 213a and a portion of a decorative surface 111a that corresponds to a general portion 214 are formed of the sheet base 241. The sheet base 241 is formed of a plastic in which a colorant is dispersed.

According to this configuration, the plastic sheet base 241, in which a colorant is dispersed, is disposed on the outermost surface of the first exterior member 211. Accordingly, matching the color of the sheet base 241 with the color of the colored layer (not shown) of the second exterior member 12, which is another general exterior member disposed around the first exterior member 211, improves the uniformity of the appearance between the first exterior member 211 and the surrounding second exterior member 12.

In addition, according to the above-described configuration, it is possible to efficiently melt ice and snow accumulated on the decorative surface 213a. Furthermore, since the heating wire 43 is covered with the sheet base 241, in which the colorant is dispersed, the heating wire 43 is not visible. Therefore, the aesthetic properties of the sensor cover portion 213, and consequently of the first exterior member 211, are not impaired.

Therefore, it is possible to improve the uniformity of the appearance of the first exterior member 211 and the second exterior member 12, which is disposed around the first exterior member 211, while improving the snow-melting function.

The vehicle exterior components according to the present disclosure are not limited to vehicle exterior components in which the sensor cover portion 13 (113) and the general portion 14 (114) are flush with each other as illustrated in the above-described embodiments. For example, in the vehicle exterior component, the sensor cover portion 13 (113) and the general portion 14 (114) may be continuous with each other via a step, or may be adjacent to each other with a gap (a hole extending in the front-rear direction L) in between.

The vehicle exterior components according to the present disclosure are not limited to vehicle exterior components in which the sensor cover portion 13 (113) and the general portion 14 (114) are integrated with each other as illustrated in the above-described embodiments. For example, in the vehicle exterior component, the sensor cover portion 13 (113) may be provided separately from the general portion 14 (114). In this case, the sensor cover portion 13 (113) corresponds to a vehicle exterior component according to the present disclosure, and the general portion 14 (114) corresponds to an exterior member disposed around the vehicle exterior component.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior component, comprising:
a plate-shaped base formed of a plastic;
a heater sheet stacked on one end face of the base in a thickness direction of the base; and
a colored layer formed of a plastic in which a colorant is dispersed or formed of a paint containing a coloring pigment, wherein
the one end face of the base forms a surface on which a decorative surface of the vehicle exterior component is located,
the heater sheet includes:
a plastic sheet base joined to the one end face of the base; and
a heating wire that is routed along the sheet base and generates heat when energized, and
the colored layer is provided on a side of the sheet base that is opposite to the base in the thickness direction.

2. The vehicle exterior component according to claim 1, wherein the base has visible light transparency and forms a surface of the vehicle exterior component that is on a side opposite to the decorative surface.

3. The vehicle exterior component according to claim 2, wherein
the sheet base is a first sheet base,
the vehicle exterior component further comprises a second sheet base formed of a plastic having a higher weather resistance than the plastic forming the first sheet base, and
the second sheet base is provided between the first sheet base and the colored layer in the thickness direction.

4. The vehicle exterior component according to claim 2, wherein the colored layer is formed of the plastic in which the colorant is dispersed, the plastic having a higher weather resistance than the plastic forming the sheet base.

5. The vehicle exterior component according to claim 1, wherein the vehicle exterior component has millimeter wave transparency.

6. A vehicle exterior component, comprising:
a plate-shaped base formed of a plastic; and
a heater sheet stacked on one end face of the base in a thickness direction of the base, wherein
the one end face of the base forms a surface on which a decorative surface of the vehicle exterior component is located,
the heater sheet includes:
a plastic sheet base joined to the one end face of the base; and
a heating wire that is routed along the sheet base and generates heat when energized, and
a colorant is dispersed in the sheet base.
